(19) United States
(12) Patent Application Publication
(10) Pub. No.: US 2022/0303148 A1
(43) Pub. Date: Sep. 22, 2022

(54) Secure Virtual Meetings

(71) Applicant: AT&T Intellectual Property I, L.P., Atlanta, GA (US)

(72) Inventors: Wei Wang, Harrison, NJ (US); Cristina Serban, Sarasota, FL (US)

(73) Assignee: AT&T Intellectual Property I, L.P., Atlanta, GA (US)

(21) Appl. No.: 17/208,131

(22) Filed: Mar. 22, 2021

(51) Int. Cl. H04L 12/18

(52) U.S. Cl. CPC H04L 12/1822; H04L 12/1818

(57) ABSTRACT

Concepts and technologies disclosed herein are directed to secure virtual meetings. According to one aspect, a user system can execute a secure virtual meeting module to identify a user that is to participate in a virtual meeting. The secure virtual meeting module can identify an authorized meeting environment in which the user is authorized to participate in the virtual meeting. The secure virtual meeting module can determine if the user is present in the authorized meeting environment, if an unauthorized person is present in the authorized meeting environment, and if a device is operating in a listening mode. In response to determining that the user is present in the authorized meeting environment, the unauthorized person is not present in the authorized meeting environment, and the device is not operating in the listening mode, the secure virtual meeting module can instruct a virtual meeting application to begin the virtual meeting.

### BACKGROUND

Traditionally, employers provide a physical office in which employees can perform work tasks. While some work tasks require an employee to be present in a physical office, many work tasks can be performed remotely. For this reason, employers may allow employees to work from home from time to time. As technologies such a virtual private network (“VPNs”), remote desktop, collaboration tools, and virtual meeting software have improved, remote work has become popular to the extent that some employers are foregoing the traditional physical office in favor of a virtual office in which employees work from home as standard practice. Other employers may offer remote work days as a benefit to employees and to provide an overall more flexible workday. In some circumstances, employers may be further encouraged to allow remote work through tax incentives granted by their local, state, and/or federal government.

Unlike a physical office environment, virtual offices can be located anywhere and may even change from time to time. For example, an employee may work from home some days, work from a public place such as a library or coffeehouse on other days, and even while on vacation at a hotel or vacation rental. Virtual offices therefore present many new challenges, not the least of which are security challenges. Employers can have strict security policies in a physical office with regard to physical and Internet access and technology use, but likely cannot individually manage the virtual office(s) of each and every employee. Employers therefore cannot ensure that other people and/or devices are not privy to confidential information when employee work remotely.

Employers may provide a set of recommendations or tips to employees that work remotely. For example, employers may make general recommendations such as to work in a separate room and close the door during telephone calls and virtual meetings to avoid disclosure of potentially sensitive information to others in the household or other environment in which an employee is working. This might be sufficient privacy for some discussions, but others might require additional security measures to ensure that highly sensitive information is not disclosed outside of those participating in the discussion. Employers may also instruct employees to configure their network connection using specific settings to conform to policies for WI-FI, cellular, and/or VPN access.

In recent years, consumers have adopted voice-enabled home assistants and other smart home devices. A voice-enabled home assistant may have a trigger word or phrase that, when spoken, allows a user to engage with the device using natural language. Although these devices usually do not record and store audio unless explicitly instructed, these devices do listen for the trigger word or phrase and respond if the trigger word or phrase is detected. Certain features of these devices may require additional listening to be enabled. Security vulnerabilities in these devices may expose live access and/or recordings to malicious entities. Employers likely do not know whether their employees have voice-enabled home assistants and/or other smart home devices that have listening modes or similar functionality, thus increasing the risk of errant disclosure of confidential information.

### SUMMARY

Concepts and technologies disclosed herein are directed to secure virtual meetings. According to one aspect disclosed herein, a user system can execute a secure virtual meeting module to identify a user that is to participate in a virtual meeting. The secure virtual meeting module can identify an authorized meeting environment in which the user is authorized to participate in the virtual meeting. The secure virtual meeting module can determine if the user is present in the authorized meeting environment, if an unauthorized person is present in the authorized meeting environment, and if a device is operating in a listening mode. In response to determining that the user is present in the authorized meeting environment, the unauthorized person is not present in the authorized meeting environment, and the device is not operating in the listening mode, the secure virtual meeting module can instruct a virtual meeting application to begin the virtual meeting.

In some embodiments, the secure virtual meeting module can identify the user that is to participate in the virtual meeting by utilizing a camera component of the user system to identify the user. In some embodiments, the secure virtual meeting module can identify the user that is to participate in the virtual meeting by utilizing a facial recognition technology to identify the user.

In some embodiments, the secure virtual meeting module can identify the authorized meeting environment in which the user is authorized to participate in the virtual meeting as an entire field of view of the camera component. In other embodiments, the secure virtual meeting module can identify the authorized meeting environment as a portion of a field of view of the camera component. The portion of the field of view of the camera component can be defined, at least in part, by one or more virtual boundaries. In some embodiments, the portion of the field of view can be defined, at least in part, by a policy.

In some embodiments, the secure virtual meeting module can, in response to determining that the user is not present in the authorized meeting environment, instruct the virtual meeting application to delay the virtual meeting. In some embodiments, the secure virtual meeting module can, in response to determining that the unauthorized person is present in the authorized meeting environment or that the device is operating in the listening mode, present a warning to the user. In some embodiments, the secure virtual meeting module can, in response to determining that the unauthorized person is present in the authorized meeting environment or that the device is operating in the listening mode, generate and send an alarm to a meeting data owner. In some embodiments, the secure virtual meeting module can, in response to determining that the unauthorized person is present in the authorized meeting environment or that the device is operating in the listening mode, perform a remedial action.

According to another aspect disclosed herein, the secure virtual meeting module can monitor an authorized meeting environment of a user participating in a virtual meeting. The secure virtual meeting module can determine if the user is present in the authorized meeting environment. The secure virtual meeting module can determine if an unauthorized person is present in the authorized meeting environment. The secure virtual meeting module can determine if a device is operating in a listening mode. In response to determining that the user is not present in the authorized meeting environment, the unauthorized person is present in the authorized meeting environment, or the device is operating in the listening mode, the secure virtual meeting module can generate an alarm. In some embodiments, the alarm is based upon a policy.

In some embodiments, the secure virtual meeting module can generate a report. The report can include the alarm. The secure virtual meeting module can cause the user system to send the report to a meeting data owner. In some embodiments, the report is based upon a policy.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts disclosed herein.

FIGS. 2A-2B are graphical user interface (“GUI”) diagrams illustrating aspects of an exemplary GUI of meeting software, according to illustrative embodiments.

FIG. 3 is a flow diagram illustrating aspects of a method for providing a secure virtual meeting during a pre-meeting phase, according to an illustrative embodiment.

FIG. 4 is a flow diagram illustrating aspects of a method for providing a secure virtual meeting during a meeting phase and a meeting end phase, according to an illustrative embodiment.

FIG. 5 is a block diagram illustrating an example computer system, according to some illustrative embodiments.

FIG. 6 is a block diagram illustrating an example mobile device, according to some illustrative embodiments.

FIG. 7 schematically illustrates a network, according to an illustrative embodiment.

FIG. 8 is a diagram illustrating a machine learning system, according to an illustrative embodiment.

FIG. 9 is a block diagram illustrating an example containerized cloud architecture and components thereof capable of implementing aspects of the embodiments presented herein.

FIG. 10 is a block diagram illustrating an example virtualized cloud architecture and components thereof capable of implementing aspects of the embodiments presented herein.

### DETAILED DESCRIPTION

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

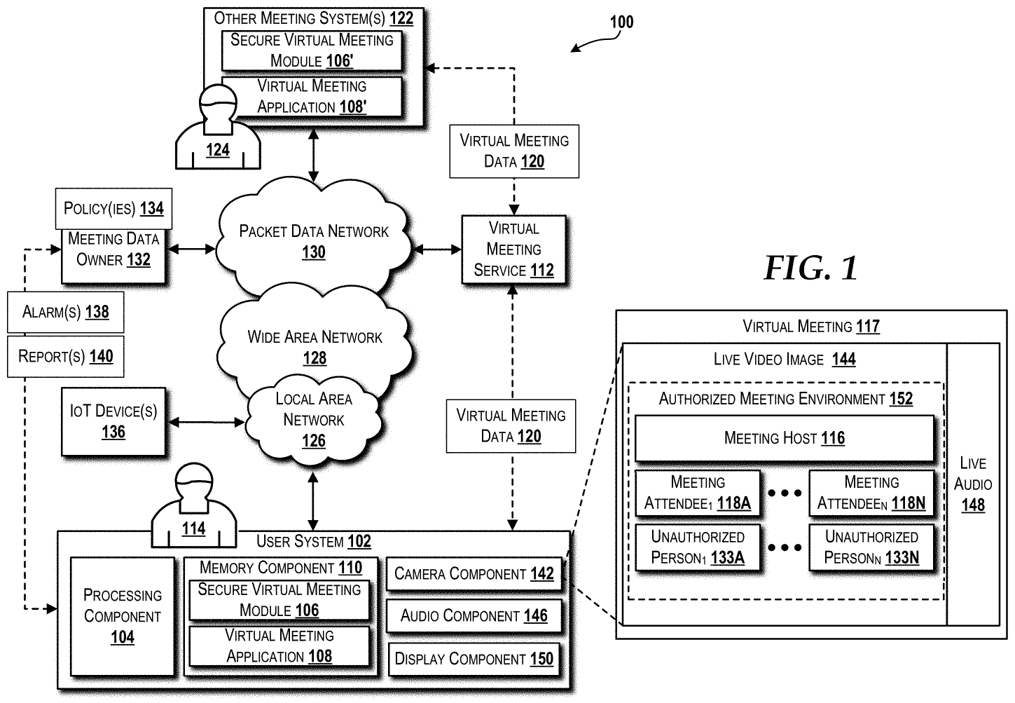

Turning now to FIG. 1, an operating environment 100 in which embodiments of the concepts and technologies disclosed herein will be described. The operating environment 100 includes a user system 102 that includes a processing component 104 to execute instructions for a secure virtual meeting module 106 and a virtual meeting application 108 stored in a memory component 110. The secure virtual meeting module 106 can be separate from or integrated with the virtual meeting application 108. The secure virtual meeting module 106 can be implemented as an application programming interface (“API”). The secure virtual meeting module 106 can be implemented as a plug-in to the virtual meeting application 108. Other implementations of the secure virtual meeting module 106 are contemplated, and as such, the examples provided herein should not be construed as being limiting in any way.

The virtual meeting application 108 can provide client-side functionality for a virtual meeting service 112 through which a user 114 associated with the user system 102 can be a meeting host 116 to host a virtual meeting 117 and/or participate in the virtual meeting 117 as one of one or more meeting attendees 118A-118N (hereinafter referred to collectively as “meeting attendees 118” or individually as “meeting attendee 118”). The virtual meeting service 112 can facilitate the exchange of virtual meeting data 120 among the virtual meeting application 108 executed by the user system 102 and a similar virtual meeting application 108′ executed by one or more other meeting systems 122 associated with one or more other users 124, each of whom can also be the meeting host 116 of the virtual meeting 117 and/or participate in the virtual meeting 117 as one of the meeting attendees 118. As used herein, the term “virtual meeting” broadly encompasses any situation in which the user 114 and one or more of the meeting attendees 118 interact via the virtual meeting service 112. Accordingly, the virtual meeting 117 can include, but is not limited to, a video call between two or more individuals, a virtual gathering of friends, a work meeting, a social meeting, a meeting associated with playing a video game or a tabletop game, or the like.

In the illustrated example, the user system 102 is operating in communication with a local area network (“LAN”) 126, which may be embodied as a wireless LAN (“WLAN”) or a wired LAN. The LAN 126 may be a home WI-FI network of the user 114. Alternatively, the LAN 126 may be another WI-FI network associated with another location in which the user 114 is remotely working via the user system 102. The LAN 126 can operate in communication with a wide area network (“WAN”) 128. The WAN 128 can be provided by one or more Internet service providers (“ISPs”) to facilitate connectivity between LANs (e.g., the LAN 126) and a packet data network (“PDN”) 130 (e.g., the Internet). The WAN 128 can be a wireless WAN (“WWAN”) provided by a mobile service provider. The other meeting system(s) 122 are shown operating in direct communication with the PDN 130. Those skilled in the art will appreciate that the other meeting system(s) 122 may access the PDN 130 through one or more LANs (similar to the LAN 126) and one or more WANs (similar to or the same as the WAN 128). It should be understood that, in some instances, the user system 102 and the other meeting system(s) 122 may operate in communication with the same network(s).

The virtual meeting data 120 may be owned by a meeting data owner 132, such as an employer of the user 114 and/or the other user(s) 124. For example, the meeting data owner 132 may have in place an agreement (e.g., an employment contract) that specifies certain data, such as the virtual meeting data 120, is owned by the meeting data owner 132. The virtual meeting data 120 can refer to the audio, video, text, and any other data associated with the virtual meeting 117. The virtual meeting data 120 can also include any meeting scheduling information such as names and contact information for the meeting host 116 and the meeting attendee(s) 118, the date and time of the virtual meeting 117, any documents or other information to be shared during the virtual meeting 117, and any credentials needed to access the virtual meeting 117 (e.g., URL, meeting code, access code, unique attendee ID, call-in telephone number, and/or the like).

The meeting data owner 132 may own all or a portion of the virtual meeting data 120 in any form referenced above. Alternatively, the meeting data owner 132 might not own the virtual meeting data 120 itself, but the content of the virtual meeting data 120. For example, the virtual meeting data 120 embodied as audio and video captured of the virtual meeting 117 may contain content discussed that is proprietary and/or confidential in nature, such as discussions about current or future products or services, intellectual property, financial matters, personnel matters, and the like. The virtual meeting data 120 may also contain non-confidential data. The concepts and technologies disclosed herein may be most beneficial when used in context of proprietary and/or confidential virtual meeting data 120, but the concepts and technologies disclosed herein can be applied to non-proprietary and/or non-confidential virtual meeting data 120 as well.

As an employer, the meeting data owner 132 may want to ensure that the meeting host 116 and the meeting attendee(s) 118 of the virtual meeting 117 are authorized to do so. Moreover, the meeting data owner 132 also may want to ensure that no unauthorized persons 133A-133N (referred to herein collectively as “unauthorized persons 133” or individually as “unauthorized person 133”) are in attendance in the virtual meeting 117. An unauthorized person 133 is not necessarily an individual with malicious intent such as to steal all or a portion of the virtual meeting data 120 or to eavesdrop on conversations held during the virtual meeting 117. In many real-world instances, the unauthorized person 133 is likely to be a friend or family member of the meeting host 116 and/or one or more of the meeting attendees 118 who happen upon the virtual meeting 117 in progress. This is primarily the case in other remote work environments as well. For example, if the user 114 has setup the user system 102 as a remote work station in a coffeehouse, library, hotel, or other public or semi-private location, the unauthorized persons 133 may be employees, visitors, or patrons. These individuals may have no concern for the content of the virtual meeting 117, but the sensitivity of the virtual meeting data 120 may demand precautions using the concepts and technologies disclosed herein to ensure that the virtual meeting data 120 or any derivation thereof is not accessible in any way by the unauthorized persons 133.

The meeting data owner 132 may establish one or more policies 134 (referred to herein collectively as “policies 134” or individually as “policy 134”). The policies 134 can be general policies that apply to all users, including the user 114 and the other user(s) 124, or specific policies that apply to specific users, such as only the user 114, or a specific grouping of users, such as the user 114 and a certain other user 124. The policies 134 can be established for all virtual meetings 117 or only certain virtual meetings 117. The policies 134 can be established for certain physical locations (e.g., a user's home or other remote work environment) or only certain physical locations (e.g., a more public location such as a coffeehouse). The policies 134 can define what constitutes an unauthorized person 133. For example, any individual who is not the meeting host 116 or one of the meeting attendees 118 may constitute an unauthorized person 133 according to one policy 134. An individual such as a spouse or child of the meeting host 116 or one of the meeting attendees 118 may, for example, constitute an unauthorized person 133 according to one policy 134 but may constitute an authorized person according to another policy 134. The policies 134 therefore may specify other authorized persons that are not the meeting host 116 or the meeting attendees 118 but are considered non-threatening or low liability and therefore not categorized as an unauthorized person 133. The level of scrutiny of who does and who does not constitute an unauthorized person 133 can be defined through the policies 134 in any number of ways. Accordingly, the aforementioned examples are merely illustrative and not intended to be limiting in any way.

As noted above, many devices exist that feature audio and/or video recording, such as voice-enabled home assistants and other smart home devices, smartphones, digital voice recorders, and the like. In the illustrated example, such devices are generally represented as Internet of Things (“IoT”) devices 136 (hereinafter referred to collectively as “IoT devices 136” or individually as “IoT device 136”). For ease of illustration, the IoT devices 136 are all operating in communication with the local area network 126 to which the user system 102 is also connected. It should be understood that the IoT devices 136 may utilize alternative connectivity to the WAN 128 and/or the PDN 130. Moreover, the IoT devices 136 are described herein as having recording functionality to record video via an IoT video camera component (not shown) and/or audio via an IoT audio component (also not shown). The IoT devices 136 may provide functionality beyond video and/or audio recording, such as home assistant or other smart home functions (e.g., home automation control), although this additional functionality may or may not affect the privacy of the virtual meeting data 120. The policies 134 can specify whether or not the IoT device(s) 136 are allowed to operate during the virtual meeting 117. For example, the policies 134 may require that the IoT device(s) 136 be powered off in preparation for and during the virtual meeting 117. Attentively, the policies 134 may require that certain functionality, such as audio and/or video recording, be disabled in preparation for and during the virtual meeting 117. These policies 134 may be expanded to require tests to ensure the IoT devices 136 are not able to record any part of a virtual meeting. An example test may be to request that the user 114 say the trigger word or phrase to see if the IoT device 136, embodied as a voice-enabled home assistant, responds, which would indicate that the IoT device 136 currently powered on and operating in a listening mode. In some embodiments, the secure virtual meeting module 106 can include IoT device sniffer/packet analyzer functionality to identify any IoT devices 136 connected to the LAN 126. For example, the secure virtual meeting module 106 can be configured to intercept traffic to/from the IoT devices 136. The secure virtual meeting module 106 alternatively may communicate with a LAN router (not shown) that can perform IoT device sniffer/packet analyzer functionality and inform the secure virtual meeting module 106 when the IoT devices 136 are actively receiving/transmitting packets on the LAN 126. In some embodiments, the secure virtual meeting module 106 can be given permission to control the IoT devices 136 such as to power off the IoT devices 136 or certain functionality thereof in preparation for and during the virtual meeting 117. The IoT devices 136 may be configured to be remotely controlled by a hub device (not shown) and/or a separate software application executed by the user system 102. In some embodiments, software associated with the IoT devices 136 can expose an application programming interface (“API”) that the secure virtual meeting module 106 can call to access functionality of the IoT devices 136 such as to control power on/off functionality and/or control other functionality.

The meeting data owner 132 may request, from the secure virtual meeting module 106, that one or more alarms 138 be triggered in certain circumstances, which may be defined, for example, in the policies 134. The meeting data owner 132 additionally or alternatively may request, from the secure virtual meeting module 106, that a report 140 be generated and provided after the virtual meeting 117 has ended. The report 140 can include any alarms 138 that were triggered during the virtual meeting 117 and/or additional details about the virtual meeting 117, including any violations or potential violations of the policies 134. The meeting data owner 132 can utilize the information in the report 140 to reprimand the user 114, to enforce or reinforce the policies 134, to develop new policies 134, and/or to modify existing policies 134. The secure virtual meeting module 106 can additionally track the history of the user 114 and can identify repeat problems (e.g., violations of one or more of the policies 134). The report 140 can additionally notify the user 114 of repeat violations. Although not shown in the illustrated example, similar alarm(s) 138 and/or report(s) 140 can be generated by a secure virtual meeting module 106′ executed by the other meeting system(s) 122. It should be understood that the policies 134 applied to the user 114 and the other user(s) 124 may be the same or different, and likewise, the alarm(s) 138 and/or the report(s) 140 may also be the same or different. The alarm(s) 138 and/or report(s) 140 also may be shared with the meeting host 116 in some implementations.

Returning to the user system 102, the processing component 104 can include a central processing unit (“CPU”) configured to process data, execute computer-executable instructions of one or more application programs (e.g., the secure virtual meeting module 106 and the virtual meeting application 108), and communicate with other components of the user system 102 in order to perform various functionality described herein. In some embodiments, the processing component 104 includes a graphics processing unit (“GPU”) configured to accelerate operations performed by the CPU, including, but not limited to, execution of the virtual meeting application 108 video components thereof, general-purpose scientific and engineering computing applications, as well as graphics-intensive computing applications such as high resolution video (e.g., 480i/p, 720i/p, 1080i/p, 4K, 8K, and greater resolutions), video games, three-dimensional modeling applications, and the like. In some embodiments, the processing component 104 can communicate with a discrete GPU (not shown). In any case, the CPU and GPU can be configured in accordance with a co-processing CPU/GPU computing model, wherein the sequential part of an application executes on the CPU and the computationally-intensive part, such as the generation and presentation of video, graphics, and other aspects of the virtual meeting 117, is accelerated by the GPU. In some embodiments, the processing component 104 is, or is included in, a system-on-chip (“SoC”) along with one or more of the other components described herein below. For example, the SoC can include the processing component 104 and the memory component 110. In some embodiments, the processing component 104 is fabricated, in part, utilizing a package-on-package (“PoP”) integrated circuit packaging technique. Moreover, the processing component 104 can be a single core or multi-core processor. The processing component 104 can be created in accordance with an ARM architecture, available for license from ARM HOLDINGS of Cambridge, United Kingdom. Alternatively, the processing component 104 can be created in accordance with an x86 architecture, such as is available from INTEL CORPORATION of Mountain View, Calif. and others. In some embodiments, the processing component 104 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory component 110 can include random access memory (“RAM”), read-only memory (“ROM”), integrated storage memory, removable storage memory, or any combination thereof. In some embodiments, at least a portion of the memory component 110 is integrated with the processing component 104. In some embodiments, the memory component 110 is configured to store a firmware, an operating system or a portion thereof (e.g., operating system kernel), one or more applications (e.g., the secure virtual meeting module 106 and the virtual meeting application 108), and/or a bootloader to load an operating system kernel. Integrated storage memory can include a solid-state memory, a hard disk, or a combination of solid-state memory and a hard disk. The integrated storage memory can be soldered or otherwise connected to a logic board upon which the processing component 104 and other components described herein also may be connected. The integrated storage memory can store an operating system or portions thereof, application programs, data, and other software components described herein. Removable storage memory can include a solid-state memory, a hard disk, or a combination of solid-state memory and a hard disk. In some embodiments, the removable storage memory is provided in lieu of the integrated storage memory. In other embodiments, the removable storage memory is provided as additional optional storage. In some embodiments, the removable storage memory is logically combined with the integrated storage memory such that the total available storage is made available and shown to a user as a total combined capacity. The removable storage memory can be inserted into a removable storage memory slot (not shown) or other mechanism by which the removable storage memory is inserted and secured to facilitate a connection over which the removable storage memory can communicate with other components of the user system 102, such as the processing component 104. The removable storage memory can be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like. It should be understood that the memory component 110 can store an operating system. According to various embodiments, the operating system includes, but is not limited to, LINUX, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The user system 102 also includes a camera component 142 that can be used to capture a live video image 144 of the user 114 during the virtual meeting 117. The camera component 142 can include an internal camera component of the user system 102. For example, the user system 102 may be a laptop computer that includes an integrated web camera. Alternatively, the camera component 142 can be built-in to another component of the user system 102, such as a display component 150 (described below). The camera component 142 alternatively can be a standalone camera component such as a standalone web camera. In addition to the camera component 142 used to capture the live video image 144, an additional camera component 142 can be used to observe the area surrounding the user 114 to detect any unauthorized person(s) 133. The additional camera component 142 may be a 360 degree camera, for example. In some embodiments, one or more of the policies 134 may require the use of additional camera components 142, such as a 360 degree camera, to observe the area surrounding the user 114 during the virtual meeting 117.

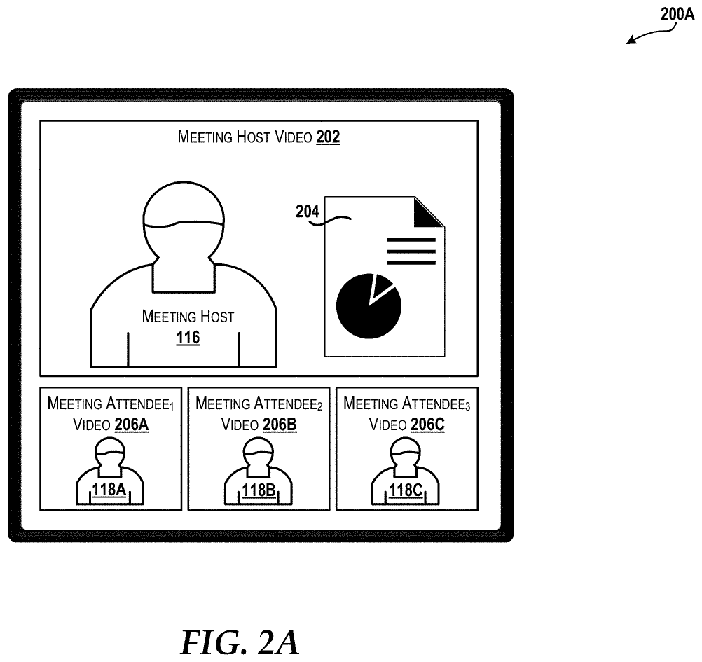

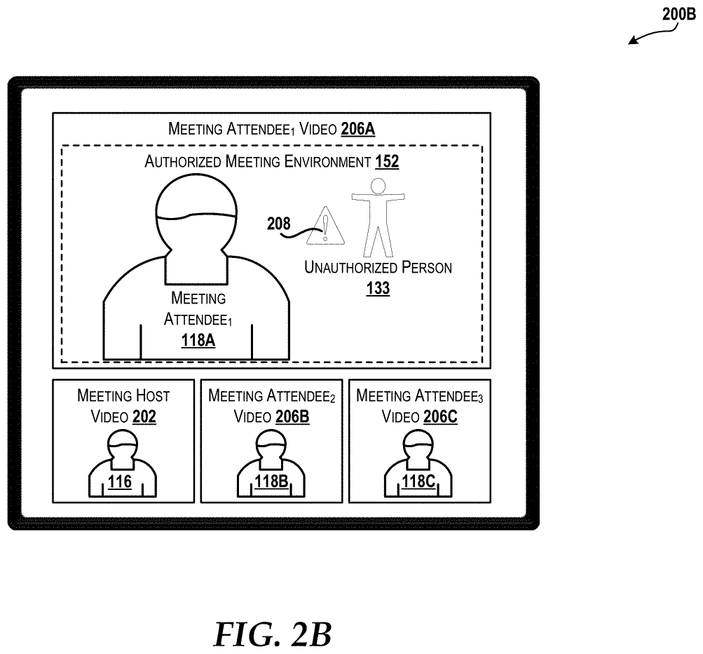

As noted above, the user 114 may be the meeting host 116 and/or the meeting attendee 118. For example, the user 114 may be the meeting host 116 for a portion of the virtual meeting 117 and the meeting attendee 118 for another portion of the virtual meeting 117. The illustrated example shows both the meeting host 116 and the meeting attendees 118 for ease of illustration. The live video image 144 alternatively may represent live video captured of the user 114 locally by the user system 102 via the camera component 142 and additionally live video captured of the other user(s) 124 remotely by the other meeting system(s) 122 via similar camera component. Additional graphics and other GUI elements can accompany the live video image 144. Examples of an illustrative GUI are illustrated and described herein with reference to FIGS. 2A-2B.

The user system 102 also includes an audio component 146 that can be used to capture live audio 148 during the virtual meeting 117. As such, the audio component 146 can include one or more speakers for the output of at least a portion of the live audio 148 to be heard by the user 114 (e.g., audio generated by the other user(s) 124) and one or more microphones for the collection and/or input of audio signals to be heard by the other user(s) 124 (e.g., audio generated by the user 114).

The user system 102 can output the live video image 144 via a display component 150. The display component 150 can be or can include one or more monitors, televisions, projectors, virtual reality (“VR”) headsets, and/or other display devices. The display component 150 can be standalone and connected to the user system 102 via a video cable such as high definition media interface (“HDMI”) or DisplayPort. The display component 150 alternatively can be integrated into the user system 102 (e.g., a laptop with an integrated display).

The format of the live video image 144 and the live audio 148 can be selected based on the needs of a given implementation. As one non-limiting example, the live video image 144 and the live audio 148 may be recorded in MPEG-4 Part 14 (“MP4”), although other file formats are contemplated. A recording of the live video image 144 and the live video image 144 can be stored locally on the user system 102 and/or the other meeting system(s) 122 and/or remotely by the virtual meeting service 112 (e.g., in cloud-based storage). The recording may be stored temporarily or permanently. The virtual meeting data 120 can include the recording as well as any text or still images exchanged during the virtual meeting. It should be understood that the quality of the live video image 144 and the live audio 148 may vary due to the capabilities of the user system 102, the other meeting system(s) 122, the virtual meeting service 112, connectivity to the various networks 126/128/130, and/or for other reasons. As such, audio and video settings such as resolution, bitrate, sampling rate, and the like may be set as needed to accommodate various implementations.

The secure virtual meeting module 106 can perform operations before the virtual meeting 117 begins, during the virtual meeting 117, and after the virtual meeting 117 ends. Before the virtual meeting 117 begins, the secure virtual meeting module 106 can utilize the camera component 142 to identify the user 114. In some embodiments, the secure virtual meeting module 106 can prompt the user 114 to perform a pre-meeting test to ensure that the camera component 142, the audio component 146, and the display component 150 are working correctly. Assuming the pre-meeting test is passed, the secure virtual meeting module 106 can identify the user 114 as an authorized person that can participate in the virtual meeting 117 as the meeting host 116 and/or the meeting attendee 118. In some embodiments, the virtual meeting application 108 can share meeting scheduling information (e.g., as part of the virtual meeting data 120) with the secure virtual meeting module 106. The secure virtual meeting module 106 can utilize this information to identify the user 114 based on their name, host ID, attendee ID, photo ID, or some combination thereof. It is contemplated that the secure virtual meeting module 106 can utilize other tools such as biometrics (e.g., facial recognition) to verify the identity of the user 114. In some embodiments, the secure virtual meeting module 106 can accept manual input identifying the user 114. For example, the camera component 142 can identify that a person is viewable in the live video image 144 and the user 114 can tag themselves as that person. In any case, the secure virtual meeting module 106 can identify the user 114 as an authorized person who is going to participate in the virtual meeting 117.

Before the virtual meeting 117 begins, the secure virtual meeting module 106 also can identify an authorized meeting environment 152. In some embodiments, the authorized meeting environment 152 includes an entire field of view of the camera component 142. If an unauthorized person 133 appears anywhere in the field of view of the camera component 142, the secure virtual meeting module 106 can trigger the creation of the alarm 138 to notify the meeting data owner 132 and/or the meeting host 116 in accordance with one or more of the policies 134. In other embodiments, the authorized meeting environment 152 include a portion of the field of view of the camera component 142, which can be defined by one or more virtual boundaries. If an unauthorized person 133 appears anywhere within the virtual boundaries, the secure virtual meeting module 106 can trigger the creation of the alarm 138 to notify the meeting data owner 132 and/or the meeting host 116 in accordance with one or more of the policies 134. It is contemplated that the authorized meeting environment 152 may be dictated, at least in part, by the policies 134. For example, a policy 134 may define minimum and/or maximum dimensions of the authorized meeting environment 152 in terms of physical measurements or viewable portions of the user 114 (such as head only or torso and head). It is also contemplated that the authorized meeting environment 152 may be different for different users 114/124 and/or for different virtual meetings 117. The authorized meeting environment 152 can be static or dynamic. The authorized meeting environment 152, in some embodiments, may be changed during the virtual meeting 117.

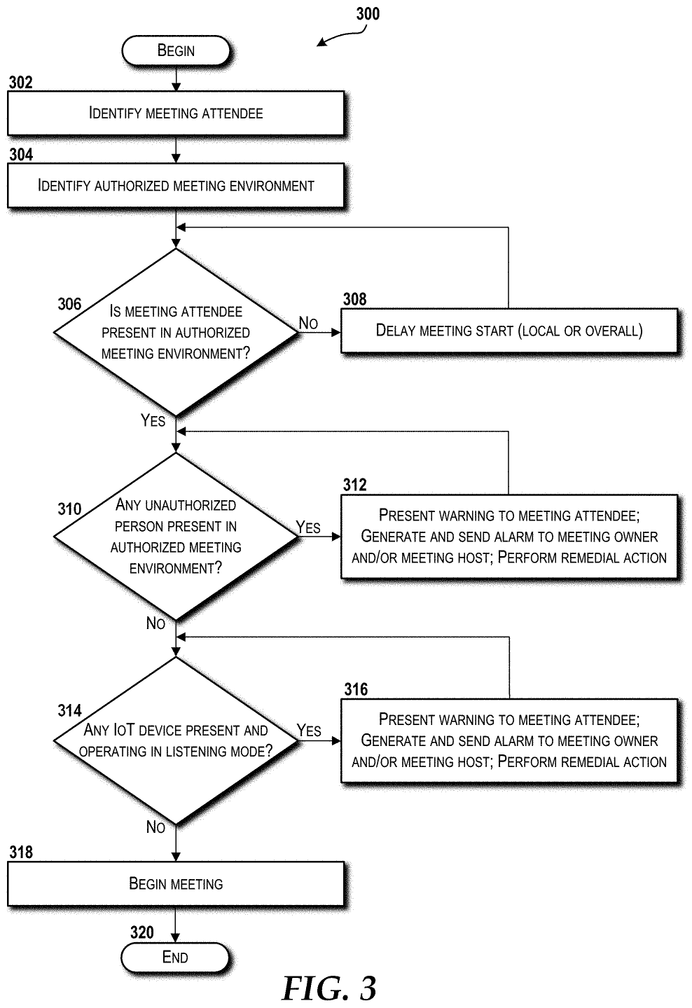

The secure virtual meeting module 106 can perform other checks before the virtual meeting 117 begins. The secure virtual meeting module 106 can check that the user 114 is present in the authorized meeting environment 152. The secure virtual meeting module 106 can check that no unauthorized persons 133 are present in the authorized meeting environment 152. The secure virtual meeting module 106 can check that none of the IoT devices 136 are powered on, or if any of the IoT devices 136 are powered on, that none of the IoT devices 136 are operating in a listening-mode or can otherwise capture audio and/or video before the virtual meeting 117 begins. Additional details about the checks the secure virtual meeting module 106 can perform before the virtual meeting 117 begins will be described herein below with reference to FIG. 3.

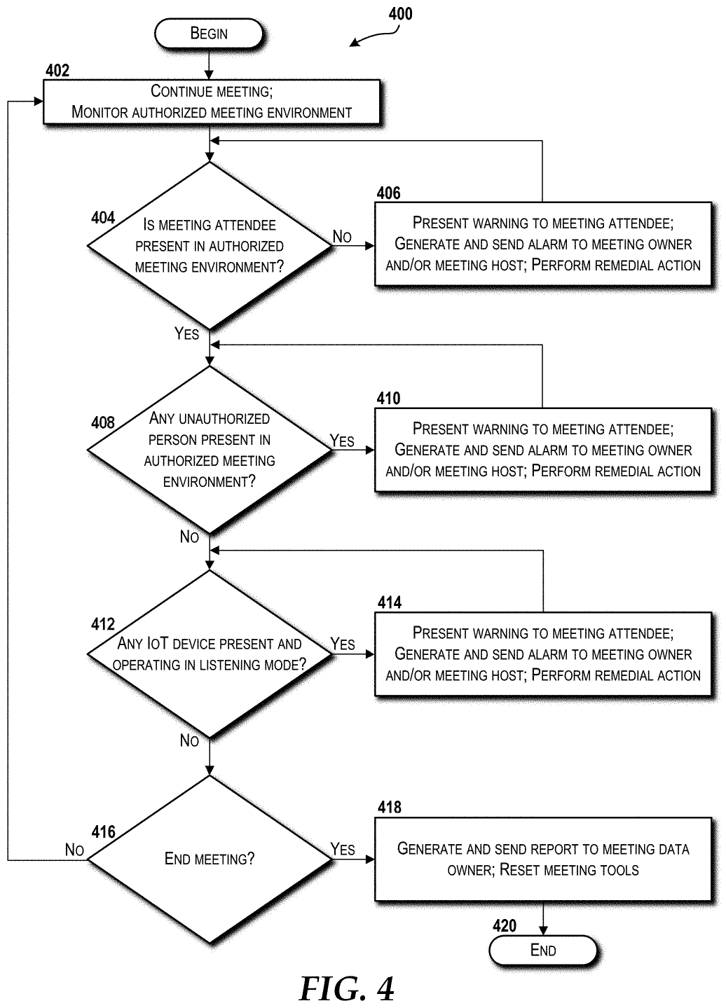

During the virtual meeting 117, the secure virtual meeting module 106 can continuously monitor the authorized meeting environment 152. The secure virtual meeting module 106 can check that the user 114 remains present in the authorized meeting environment 152. The secure virtual meeting module 106 can check that no unauthorized persons 133 enter in the authorized meeting environment 152. The secure virtual meeting module 106 can check that none of the IoT devices 136 are powered on, or if any of the IoT devices 136 are powered on, that none of the IoT devices 136 are operating in a listening-mode or can otherwise capture audio and/or video during the virtual meeting 117. At the end of the virtual meeting 117, the secure virtual meeting module 106 can generate and send the report 140 to the meeting data owner 132 and/or the meeting host 116. Additional details about the secure virtual meeting module 106 during and at the end of the virtual meeting 117 will be described herein below with reference to FIG. 4.

Turning now to FIG. 2A-2B, GUI diagrams 200A-200B illustrating various aspects of an exemplary GUI of the virtual meeting application 108 will be described, according to illustrative embodiments. Turning first to FIG. 2A, the GUI diagram 200A shows a meeting host video 202 of the meeting host 116 and a meeting presentation 204. The meeting presentation 204 can include presentation materials, including physical presentation materials viewable within the meeting host video 202 and/or digital presentation materials presented via the virtual meeting application 108. Also shown are meeting attendee videos 206A-206C for three meeting attendees 118A-118C. As described above, the user 114 can be the meeting host 116, and as such, the meeting host video 202 can be the live video image 144. The user 114 also can be one of the meeting attendees 118, and as such, the meeting attendee video 206 can be the live video image 144. Similarly, the other users 124 can be the meeting host 116 or one of the meeting attendees 118.

Turning now to FIG. 2B, the GUI diagram 200B again shows the meeting host video 202 and the meeting attendee videos 206A-206C. In this example, the secure virtual meeting module 106 detects the presence of an unauthorized person 133, and in response, generates and presents a warning icon 208. The warning icon 208 can be accompanied by an audio alert. The warning icon 208 can be presented only for the meeting attendee 118, for the meeting attendee 118 and the meeting host 116, or for all participants in the virtual meeting 117. In addition or alternatively, the secure virtual meeting module 106 can generate and send an alarm 138 to the meeting data owner 132 and/or the meeting host 116 to notify them of the presence of the unauthorized person 133. The alarm 138 also can be reported in a report 140 after the virtual meeting 117 has ended.

Turning now to FIG. 3, a flow diagram illustrating aspects of a method 300 for providing secure virtual proximity for the virtual meeting 117 during a pre-meeting phase will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as, for example, the processing component 104 of the user system 102 or similar of the other meeting system(s) 122, to perform one or more operations, and/or causing the processor to direct other components of the computing system or device to perform one or more of the operations.

For purposes of illustrating and describing the concepts of the present disclosure, operations of the methods disclosed herein are described as being performed by alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 300 will be described in context of the user 114 being one of the meeting attendees 118 of the virtual meeting 117. The user 114 alternatively may be the meeting host 116 and the operations of the method 300 can be performed in substantially the same way. The method 300 begins and proceeds to operation 302. At operation 302, the secure virtual meeting module 106 identifies the user 114 as the meeting attendee 118. In some embodiments, the secure virtual meeting module 106 can utilize the camera component 142 to identify the user 114. In some embodiments, the secure virtual meeting module 106 can prompt the user 114 to perform a pre-meeting test to ensure that the camera component 142, the audio component 146, and the display component 150 are working correctly. Assuming the pre-meeting test is passed, the secure virtual meeting module 106 can identify the user 114 as an authorized person that can participate in the virtual meeting 117. In some embodiments, the virtual meeting application 108 can share meeting scheduling information (e.g., as part of the virtual meeting data 120) with the secure virtual meeting module 106. The secure virtual meeting module 106 can utilize this information to identify the user 114 based on their name, host ID, attendee ID, photo ID, or some combination thereof. It is contemplated that the secure virtual meeting module 106 can utilize other tools such as biometrics (e.g., facial recognition) to verify the identity of the user 114. In some embodiments, the secure virtual meeting module 106 can accept manual input identifying the user 114. For example, the camera component 142 can identify that a person is viewable in the live video image 144 and the user 114 can tag themselves as that person. In any case, the secure virtual meeting module 106 can identify the user 114 as an authorized person who is going to participate in the virtual meeting 117.

From operation 302, the method 300 proceeds to operation 304. At operation 304, the secure virtual meeting module 106 identifies the authorized meeting environment 152. In some embodiments, the authorized meeting environment 152 includes an entire field of view of the camera component 142. In other embodiments, the authorized meeting environment 152 include a portion of the field of view of the camera component 142, which can be defined by one or more virtual boundaries. It is contemplated that the authorized meeting environment 152 may be dictated, at least in part, by the policies 134. For example, a policy 134 may define minimum and/or maximum dimensions of the authorized meeting environment 152 in terms of physical measurements or viewable portions of the user 114 (such as head only or torso and head). It is contemplated that the virtual boundaries can be set automatically by the secure virtual meeting module 106. The size of the virtual boundaries may be established in one or more of the policies 134.

From operation 304, the method 300 proceeds to operation 306. At operation 306, the secure virtual meeting module 106 determines if the meeting attendee 118 is present in the authorized meeting environment 152. If the meeting attendee 118 is not present in the authorized meeting environment 152, the method 300 proceeds to operation 308. At operation 308, the secure virtual meeting module 106 can delay the start of the virtual meeting 117. In some embodiments, the delay can be local such that the virtual meeting 117 starts and only the live video image 144 and the live audio 148 associated with the meeting attendee 118 are delayed. In other embodiments, the delay can be overall such that the virtual meeting 117 does not start. The method 300 then returns to operation 306, which is repeated until the meeting attendee 118 is present in the authorized meeting environment 152.

From operation 306, the method 300 proceeds to operation 310. At operation 310, the secure virtual meeting module 106 determines if any unauthorized person(s) 133 is/are present in the authorized meeting environment 152. If any unauthorized person(s) 133 is/are present in the authorized meeting environment 152, the method 300 proceeds to operation 312. At operation 312, the secure virtual meeting module 106 can present a warning to the meeting attendee 118. The warning can be audio, video, image, and/or text-based. An example warning is shown in FIG. 2B as the warning icon 208. It is contemplated that the warning may be presented to other meeting attendees 118 and/or the meeting host 116. In addition, at operation 312, the secure virtual meeting module 106 can generate and send an alarm to the meeting data owner 132 and/or the meeting host 116. The secure virtual meeting module 106 also can perform a remedial action at operation 312. The remedial action can include temporarily disabling the camera component 142, the audio component 146, the display component 150, or some combination thereof until the unauthorized person leaves the authorized meeting environment 152. Other remedial action may be to automatically leave the virtual meeting 117. Other types of actions are contemplated and may be chosen based on the specifics of a given implementation. As such, the example remedial action should not be construed as being limiting in any way. The method 300 then returns to operation 310, which is repeated until no unauthorized person(s) 133 is/are present in the authorized meeting environment. It should be understood that the warning, alarm, and remedial action may be repeated or not if the same unauthorized person 133 remains in the authorized meeting environment 152. If another unauthorized person 133 appears, a new warning, alarm, and remedial action can be used.

From operation 310, the method 300 proceeds to operation 314. At operation 314, the secure virtual meeting module 106 determines if any IoT devices 136 are present and operating in a listening mode. If the secure virtual meeting module 106 determines that at least one IoT device 136 is present and operating in a listening mode, the method 300 can proceed to operation 316. At operation 316, the secure virtual meeting module 106 can present a warning to the meeting attendee 118. The warning can be audio, video, image, and/or text-based. An example warning is shown in FIG. 2B as the warning icon 208. It is contemplated that the warning may be presented to other meeting attendees 118 and/or the meeting host 116. In addition, at operation 314, the secure virtual meeting module 106 can generate and send an alarm 138 to the meeting data owner 132 and/or the meeting host 116. The secure virtual meeting module 106 also can perform a remedial action at operation 316. The remedial action can include temporarily disabling the IoT device(s) 136 by powering off the IoT device(s) 136 or disabling certain functions such as video and/or audio recording functions. Other remedial action may be to automatically leave the virtual meeting 117. Other types of actions are contemplated and may be chosen based on the specifics of a given implementation. As such, the example remedial action should not be construed as being limiting in any way. The method 300 then returns to operation 314, which is repeated until no IoT devices 136 are detected.

From operation 314, the method 300 proceeds to operation 318. At operation 318, the virtual meeting 117 begins. From operation 318, the method 300 proceeds to operation 320. The method 300 can end at operation 320.

Turning now to FIG. 4, a flow diagram illustrating aspects of a method 400 for providing secure virtual proximity for the virtual meeting 117 during a meeting phase and a meeting end phase will be described, according to an illustrative embodiment. The method 400 begins following completion of the pre-meeting phase described in the method 300 above. The method 400 begins and proceeds to operation 402. At operation 402, the virtual meeting 117 continues and the secure virtual meeting module 106 monitors the authorized meeting environment 152. From operation 402, the method 400 proceeds to operation 404. At operation 404, the secure virtual meeting module 106 determines if the meeting attendee 118 is present in the authorized meeting environment 152. If the meeting attendee is not present in the authorized meeting environment 152, the method 400 proceeds to operation 406. At operation 406, the secure virtual meeting module 106 can present a warning to the meeting attendee 118. The warning can be audio, video, image, and/or text-based. An example warning is shown in FIG. 2B as the warning icon 208. It is contemplated that the warning may be presented to other meeting attendees 118 and/or the meeting host 116. In addition, at operation 406, the secure virtual meeting module 106 can generate and send an alarm 138 to the meeting data owner 132 and/or the meeting host 116. The secure virtual meeting module 106 also can perform a remedial action at operation 406. The remedial action can include temporarily disabling the camera component 142, the audio component 146, the display component 150, or some combination thereof until the meeting attendee 118 is present in the authorized meeting environment 152. Other remedial action may be to automatically leave the virtual meeting 117. Other types of actions are contemplated and may be chosen based on the specifics of a given implementation. As such, the example remedial action should not be construed as being limiting in any way. The method 400 then returns to operation 404, which is repeated until the meeting attendee 118 is present in the authorized meeting environment 152.

From operation 404, the method 400 proceeds to operation 408. At operation 408, the secure virtual meeting module 106 determines if any unauthorized person(s) 133 is/are present in the authorized meeting environment 152. If any unauthorized person(s) 133 is/are present in the authorized meeting environment, the method 400 proceeds to operation 410. At operation 410, the secure virtual meeting module 106 can present a warning to the meeting attendee 118. The warning can be audio, video, image, and/or text-based. An example warning is shown in FIG. 2B as the warning icon 208. It is contemplated that the warning may be presented to other meeting attendees 118 and/or the meeting host 116. In addition, at operation 410, the secure virtual meeting module 106 can generate and send an alarm 138 to the meeting data owner 132 and/or the meeting host 116. The secure virtual meeting module 106 also can perform a remedial action at operation 410. The remedial action can include temporarily disabling the camera component 142, the audio component 146, the display component 150, or some combination thereof until the unauthorized person 133 leaves the authorized meeting environment 152. Other remedial action may be to automatically leave the virtual meeting 117. Other types of actions are contemplated and may be chosen based on the specifics of a given implementation. As such, the example remedial action should not be construed as being limiting in any way. The method 400 then returns to operation 408, which is repeated until no unauthorized person(s) 133 is/are present in the authorized meeting environment 152. It should be understood that the warning, alarm, and remedial action may be repeated or not if the same unauthorized person 133 remains in the authorized meeting environment 152. If another unauthorized person 133 appears, a new warning, alarm, and remedial action can be used. The method 400 then returns to operation 408, which is repeated until no unauthorized person(s) 133 is/are present in the authorized meeting environment.

From operation 408, the method 400 proceeds to operation 412. At operation 412, the secure virtual meeting module 106 determines if any IoT devices 136 are present and operating in a listening mode. If the secure virtual meeting module 106 determines that at least one IoT device 136 is present and operating in a listening mode, the method 400 can proceed to operation 414. At operation 414, the secure virtual meeting module 106 can present a warning to the meeting attendee 118. The warning can be audio, video, image, and/or text-based. An example warning is shown in FIG. 2B as the warning icon 208. It is contemplated that the warning may be presented to other meeting attendees 118 and/or the meeting host 116. In addition, at operation 414, the secure virtual meeting module 106 can generate and send an alarm 138 to the meeting data owner 132 and/or the meeting host 116. The secure virtual meeting module 106 also can perform a remedial action at operation 414. The remedial action can include temporarily disabling the IoT device(s) 136 by powering off the IoT device(s) 136 or disabling certain functions such as video and/or audio recording functions. Other remedial action may be to automatically leave the virtual meeting 117. Other types of actions are contemplated and may be chosen based on the specifics of a given implementation. As such, the example remedial action should not be construed as being limiting in any way. The method 400 then returns to operation 412, which is repeated until no IoT devices 136 are detected.

From operation 412, the method 400 proceeds to operation 416. At operation 418, the secure virtual meeting module 106 determines if the virtual meeting 117 is to be ended. The virtual meeting 117 may end based on time (automatically end) or manually by the user 114 ending the virtual meeting 117 (or at least their participation in the virtual meeting 117). If the virtual meeting 117 is to continue, the method 400 returns to operation 402 and the method 400 proceeds as described above. If the secure virtual meeting module 106 determines that the virtual meeting 117 is to be ended, the method 400 proceeds to operation 418.

At operation 418, the secure virtual meeting module 106 generates and sends the report 140 to the meeting data owner 132. The report 140 can include any alarms 138 sent during the virtual meeting 117, any remedial actions performed, any warnings presented, and other information to summarize the virtual meeting 117 and compliance or non-compliance with the policies 134 that were applicable to the virtual meeting 117. In some embodiments, the secure virtual meeting module 106 waits until the virtual meeting 117 has ended before sending the alarms 137 to the meeting data owner 132 and/or the meeting host 16. In these embodiments, the alarms 138 may be sent separately or part of the report 140. In other embodiments, the alarms 138 are sent during the virtual meeting 117 (as described above) and summarized in the report 140 at the end of the virtual meeting 117. Also at operation 418, the secure virtual meeting module 106 can instruct the user 114 to reset any meeting tools used during the virtual meeting 117. For example, the secure virtual meeting module 106 can instruct the user 114 to clean-up any physical whiteboard (e.g., erase any meeting notes) and/or other meeting tools used during the virtual meeting 117. In some implementations, a digital whiteboard or other meeting tool can be instructed to automatically be reset before or after the virtual meeting 117 ends.

From operation 418, the method 400 proceeds to operation 420. The method 400 can end at operation 420.

The operations 404, 406, 408, 410, 412, 414, and 416 are described as being performed sequentially. In real-world implementations, the determining operations 404, 408, 412, and 416 can be performed simultaneously such that the presence of the meeting attendee 118, whether any unauthorized persons(s) 133 is/are present in the authorized meeting environment 152, and whether any IoT device(s) 136 is/are present and operating in a listening mode can be determined as part of an ongoing monitoring process performed by the secure virtual meeting module 106 during the virtual meeting 117. Accordingly, the sequential nature of the operations described above should not be construed as being limiting in any way.

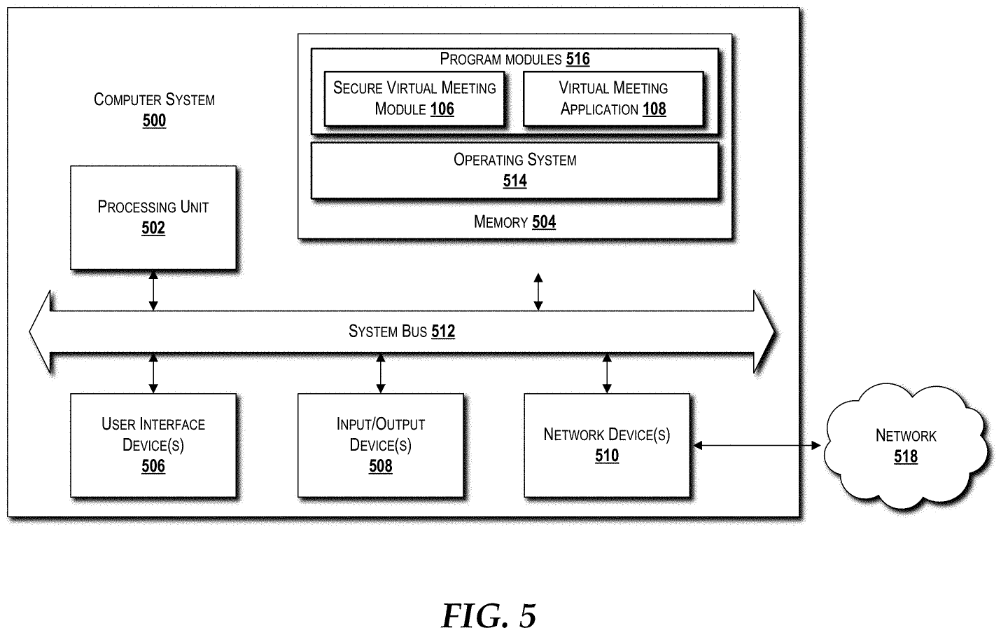

Turning now to FIG. 5, a block diagram illustrating a computer system 500 will be described, according to an illustrative embodiment. In some embodiments, the user system 102 is configured the same as or similar to the computer system 500. In some embodiments, the other meeting system(s) 122 is/are configured the same as or similar to the computer system 500. The computer system 500 includes a processing unit 502, a memory 504, one or more user interface devices 506, one or more input/output (“I/O”) devices 508, and one or more network devices 510, each of which is operatively connected to a system bus 512. The bus 512 enables bi-directional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 502 can be a single processing unit or a multiple processing unit that includes more than one processing component. In some embodiments, the processing unit 502 is or includes the processing component 104 (shown in FIG. 1).

The memory 504 communicates with the processing unit 502 via the system bus 512. The memory 504 can include a single memory component or multiple memory components. In some embodiments, the memory 504 is operatively connected to a memory controller (not shown) that enables communication with the processing unit 502 via the system bus 512. The memory 504 includes an operating system 514 and one or more program modules 516. The operating system 514 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or OSX families of operating systems from APPLE CORPORATION, the FREEBSD family of operating systems, the SOLARIS family of operating systems from ORACLE CORPORATION, other operating systems, and the like. In some embodiments, the memory 504 is or includes the memory component 110 (also shown in FIG. 1).

The program modules 516 may include various software and/or program modules described herein. In some embodiments, for example, the program modules 516 can include the secure virtual meeting module 106, the virtual meeting application 108, or both. In some embodiments, multiple implementations of the computer system 500 can be used, wherein each implementation is configured to execute one or more of the program modules 516. The program modules 516 and/or other programs can be embodied in computer-readable media containing instructions that, when executed by the processing unit 502, perform the methods 300, 400 described herein. According to embodiments, the program modules 516 may be embodied in hardware, software, firmware, or any combination thereof Although not shown in FIG. 5, it should be understood that the memory 504 also can be configured to store, at least temporarily, the virtual meeting data 120, the live video image 117, the live audio 148, the policies 134, the alarms 138, the reports 140, combinations thereof, and/or other data disclosed herein.

By way of example, and not limitation, computer-readable media may include any available computer storage media or communication media that can be accessed by the computer system 500. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500. In the claims, the phrase “computer storage medium,” “computer-readable storage medium,” and variations thereof does not include waves or signals per se and/or communication media, and therefore should be construed as being directed to “non-transitory” media only.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 516. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, an electronic stylus, the camera component 142, and/or the audio component 146 (particularly a microphone). Further, the I/O devices 508 may include one or more output devices, such as, but not limited to, the display component 150.

The network devices 510 enable the computer system 500 to communicate with other networks or remote systems via a network 518. Examples of the network devices 510 include, but are not limited to, a modem, a radio frequency (“RF”) or infrared (“IR”) transceiver, a telephonic interface, a bridge, a router, or a network card. The network 518 may include a wireless network such as, but not limited to, a WLAN (e.g., the LAN 126) such as a WI-FI network, a Wireless Wide Area Network (“WWAN”) (e.g., the WAN 128), a Wireless Personal Area Network (“WPAN”) such as BLUETOOTH, a Wireless Metropolitan Area Network (“WMAN”) such a WiMAX network, or a cellular network. Alternatively, the network 518 may be a wired network such as, but not limited to, a WAN, LAN, a wired Personal Area Network (“PAN”), or a wired Metropolitan Area Network (“MAN”).

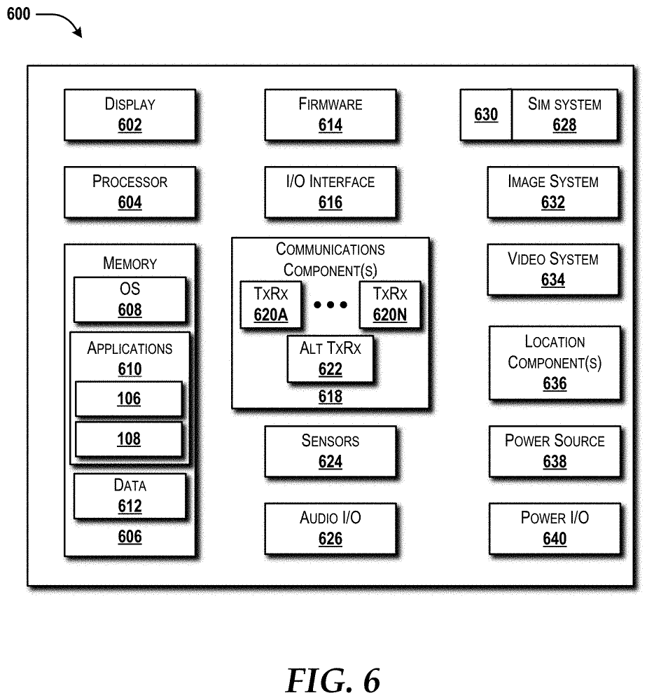

Turning now to FIG. 6, an illustrative mobile device 600 and components thereof will be described. In some embodiments, the user system 102 is configured the same as or similar to the mobile device 600. In some embodiments, the other meeting system(s) 122 is/are configured the same as or similar to the mobile device 600. While connections are not shown between the various components illustrated in FIG. 6, it should be understood that some, none, or all of the components illustrated in FIG. 6 can be configured to interact with one another to carry out various device functions. In some embodiments, the components are arranged so as to communicate via one or more busses (not shown). Thus, it should be understood that FIG. 6 and the following description are intended to provide a general understanding of a suitable environment in which various aspects of embodiments can be implemented, and should not be construed as being limiting in any way.

As illustrated in FIG. 6, the mobile device 600 can include a display 602 for displaying data. In some embodiments, the display 602 is or includes the display component 150. According to various embodiments, the display 602 can be configured to display the live video image 144, various GUI elements (e.g., the GUIs illustrated in FIGS. 2A, 2B), text, images, video, virtual keypads and/or keyboards, messaging data, notification messages, metadata, Internet content, device status, time, date, calendar data, device preferences, map and location data, combinations thereof, and/or the like. The mobile device 600 also can include a processor 604 and a memory or other data storage device (“memory”) 606. The processor 604 can be configured to process data and/or can execute computer-executable instructions stored in the memory 606. The computer-executable instructions executed by the processor 604 can include, for example, an operating system 608, one or more applications 610 (e.g., the secure virtual meeting module 106 and the virtual meeting application 108), other computer-executable instructions stored in the memory 606, or the like. In some embodiments, the applications 610 also can include a UI application (not illustrated in FIG. 6). In some embodiments, the processor 604 is or includes the processing component and the memory 606 is or includes the memory component 110.

The UI application can interface with the operating system 608 to facilitate user interaction with functionality and/or data stored at the mobile device 600 and/or stored elsewhere. In some embodiments, the operating system 608 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 604 to aid a user in entering/deleting data, entering and setting user IDs and passwords for device access, configuring settings, manipulating content and/or settings, multimode interaction, interacting with other applications 610 (e.g., the secure virtual meeting module 106 and the virtual meeting application 108), and otherwise facilitating user interaction with the operating system 608, the applications 610, and/or other types or instances of data 612 that can be stored at the mobile device 600.

The applications 610, the data 612, and/or portions thereof can be stored in the memory 606 and/or in a firmware 614, and can be executed by the processor 604. The firmware 614 also can store code for execution during device power up and power down operations. It can be appreciated that the firmware 614 can be stored in a volatile or non-volatile data storage device including, but not limited to, the memory 606 and/or a portion thereof.

The mobile device 600 also can include an input/output (“I/O”) interface 616. The I/O interface 616 can be configured to support the input/output of data such as location information, presence status information, user IDs, passwords, and application initiation (start-up) requests. In some embodiments, the I/O interface 616 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 600 can be configured to synchronize with another device to transfer content to and/or from the mobile device 600. In some embodiments, the mobile device 600 can be configured to receive updates to one or more of the applications 610 via the I/O interface 616, though this is not necessarily the case. In some embodiments, the I/O interface 616 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 616 may be used for communications between the mobile device 600 and a network device or local device.

The mobile device 600 also can include a communications component 618. The communications component 618 can be configured to interface with the processor 604 to facilitate wired and/or wireless communications with one or more networks, such as the LAN 126, the WAN 128, and/or the PDN 130 (shown in FIG. 1). In some embodiments, the communications component 618 includes a multimode communications subsystem for facilitating communications via the cellular network and one or more other networks.

The communications component 618, in some embodiments, includes one or more transceivers. The one or more transceivers, if included, can be configured to communicate over the same and/or different wireless technology standards with respect to one another. For example, in some embodiments, one or more of the transceivers of the communications component 618 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, and greater generation technology standards. Moreover, the communications component 618 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 618 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 618 can include a first transceiver (“TxRx”) 620A that can operate in a first communications mode (e.g., GSM). The communications component 618 also can include an N^{th} transceiver (“TxRx”) 620N that can operate in a second communications mode relative to the first transceiver 620A (e.g., UMTS). While two transceivers 620A-620N (hereinafter collectively and/or generically referred to as “transceivers 620”) are shown in FIG. 6, it should be appreciated that less than two, two, and/or more than two transceivers 620 can be included in the communications component 618.

The communications component 618 also can include an alternative transceiver (“Alt TxRx”) 622 for supporting other types and/or standards of communications. According to various contemplated embodiments, the alternative transceiver 622 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 618 also can facilitate reception from terrestrial radio networks, digital satellite radio networks, internet-based radio service networks, combinations thereof, and the like. The communications component 618 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 600 also can include one or more sensors 624. The sensors 624 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 600 may be provided by an audio I/O component 626. The audio I/O component 626 of the mobile device 600 can include one or more speakers for the output of audio signals, one or more microphones for the collection and/or input of audio signals, and/or other audio input and/or output devices. In some embodiments, the audio I/O component 626 is or include the audio component 146 (shown in FIG. 1).

The illustrated mobile device 600 also can include a subscriber identity module (“SIM”) system 628. The SIM system 628 can include a universal SIM (“USIM”), a universal integrated circuit card (“UICC”) and/or other identity devices. The SIM system 628 can include and/or can be connected to or inserted into an interface such as a slot interface 630. In some embodiments, the slot interface 630 can be configured to accept insertion of other identity cards or modules for accessing various types of networks. Additionally, or alternatively, the slot interface 630 can be configured to accept multiple subscriber identity cards. Because other devices and/or modules for identifying users and/or the mobile device 600 are contemplated, it should be understood that these embodiments are illustrative, and should not be construed as being limiting in any way.

The mobile device 600 also can include an image capture and processing system 632 (“image system”). The image system 632 can be configured to capture or otherwise obtain photos, videos, and/or other visual information. As such, the image system 632 can include cameras, lenses, charge-coupled devices (“CCDs”), combinations thereof, or the like. The mobile device 600 may also include a video system 634. The video system 634 can be configured to capture, process, record, modify, and/or store video content such as the live video image 144. In some embodiments, the video system 634 is or includes the camera component 142.

The mobile device 600 also can include one or more location components 636. The location components 636 can be configured to send and/or receive signals to determine a geographic location of the mobile device 600. According to various embodiments, the location components 636 can send and/or receive signals from global positioning system (“GPS”) devices, assisted-GPS (“A-GPS”) devices, WI-FI/WIMAX and/or cellular network triangulation data, combinations thereof, and the like. The location component 636 also can be configured to communicate with the communications component 618 to retrieve triangulation data for determining a location of the mobile device 600. In some embodiments, the location component 636 can interface with cellular network nodes, telephone lines, satellites, location transmitters and/or beacons, wireless network transmitters and receivers, combinations thereof, and the like. In some embodiments, the location component 636 can include and/or can communicate with one or more of the sensors 624 such as a compass, an accelerometer, and/or a gyroscope to determine the orientation of the mobile device 600. Using the location component 636, the mobile device 600 can generate and/or receive data to identify its geographic location, or to transmit data used by other devices to determine the location of the mobile device 600. The location component 636 may include multiple components for determining the location and/or orientation of the mobile device 600.

The illustrated mobile device 600 also can include a power source 638. The power source 638 can include one or more batteries, power supplies, power cells, and/or other power subsystems including alternating current (“AC”) and/or direct current (“DC”) power devices. The power source 638 also can interface with an external power system or charging equipment via a power I/O component 640. Because the mobile device 600 can include additional and/or alternative components, the above embodiment should be understood as being illustrative of one possible operating environment for various embodiments of the concepts and technologies described herein. The described embodiment of the mobile device 600 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 600 or other devices or computers described herein, such as the computer system 500 described above with reference to FIG. 5.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 600 in order to store and execute the software components presented herein. It is also contemplated that the mobile device 600 may not include all of the components shown in FIG. 6, may include other components that are not explicitly shown in FIG. 6, or may utilize an architecture completely different than that shown in FIG. 6.

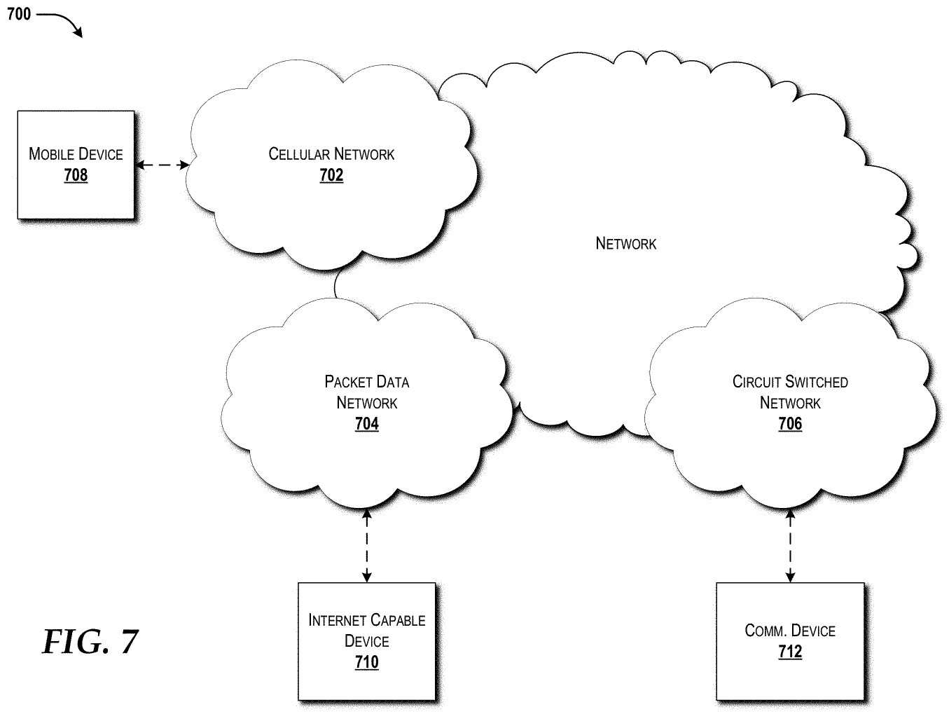

Turning now to FIG. 7, details of a network 700 are illustrated, according to an illustrative embodiment. The network 700 includes a cellular network 702, a packet data network 704, and a circuit switched network 706. In some embodiments, the network 700 is or includes the other networks disclosed herein, including the LAN 126, the WAN 128, the PDN 130, and/or the network 518. As such, the user system 102, the other meeting system(s) 122, the virtual meeting service 112, and the meeting data owner 132 can communicate via the network 700 to exchange the virtual meeting data 120 in accordance with embodiments disclosed herein.

The cellular network 702 can include various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, a cellular telephone, a user equipment, a mobile terminal, a PDA, a laptop computer, a handheld computer, and combinations thereof, can be operatively connected to the cellular network 702. The mobile communications device 708 can be configured similar to or the same as the mobile device 600 described above with reference to FIG. 6.

The cellular network 702 can be configured as a GSM network and can provide data communications via GPRS and/or EDGE. Additionally, or alternatively, the cellular network 702 can be configured as a 3G Universal Mobile Telecommunications System (“UMTS”) network and can provide data communications via the HSPA protocol family, for example, HSDPA, EUL, and HSPA+. The cellular network 702 also is compatible with 4G mobile communications standards such as LTE, 5G mobile communications standards, or the like, as well as evolved and future mobile standards. In some embodiments, the cellular network 702 is or includes the WAN 128 (as a WWAN)

The packet data network 704 includes various systems, devices, servers, computers, databases, and other devices in communication with one another, as is generally known. In some embodiments, the packet data network 704 is or includes one or more WI-FI networks, each of which can include one or more WI-FI access points, routers, switches, and other WI-FI network components. The packet data network 704 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 704 includes or is in communication with the Internet. The packet data network 704 can be or can include the PDN 130. The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable devices 710 such as the user system 102, the other meeting system(s) 122, a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710.

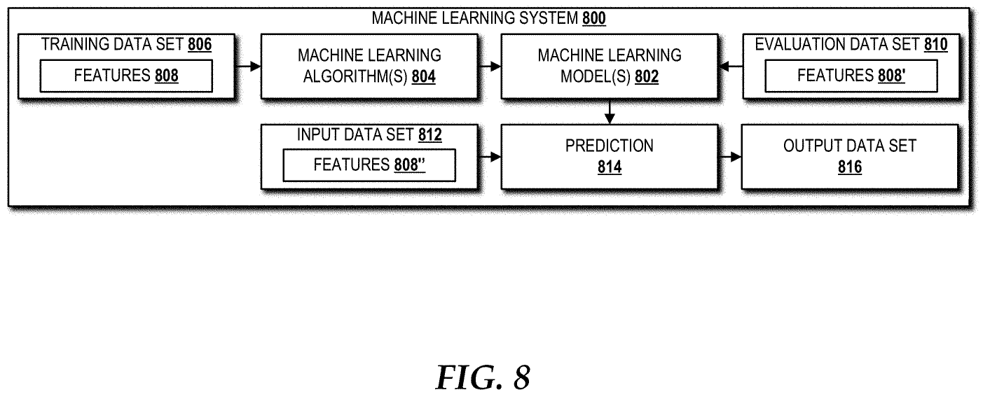

Turning now to FIG. 8, a machine learning system 800 capable of implementing aspects of the embodiments disclosed herein will be described. In some embodiments, aspects of the secure virtual meeting module 106 can be enhanced through the use of machine learning and/or artificial intelligence applications. Accordingly, the user system 102 can include the machine learning system 800 or can be in communication with the machine learning system 800.

The illustrated machine learning system 800 includes one or more machine learning models 802. The machine learning models 802 can include supervised and/or semi-supervised learning models. The machine learning model(s) 802 can be created by the machine learning system 800 based upon one or more machine learning algorithms 804. The machine learning algorithm(s) 804 can be any existing, well-known algorithm, any proprietary algorithms, or any future machine learning algorithm. Some example machine learning algorithms 804 include, but are not limited to, neural networks, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 804 based upon the problem(s) to be solved by machine learning via the machine learning system 800.

The machine learning system 800 can control the creation of the machine learning models 802 via one or more training parameters. In some embodiments, the training parameters are selected modelers at the direction of an enterprise, for example. Alternatively, in some embodiments, the training parameters are automatically selected based upon data provided in one or more training data sets 806. The training parameters can include, for example, a learning rate, a model size, a number of training passes, data shuffling, regularization, and/or other training parameters known to those skilled in the art. The training data in the training data sets 806.

The learning rate is a training parameter defined by a constant value. The learning rate affects the speed at which the machine learning algorithm 804 converges to the optimal weights. The machine learning algorithm 804 can update the weights for every data example included in the training data set 806. The size of an update is controlled by the learning rate. A learning rate that is too high might prevent the machine learning algorithm 804 from converging to the optimal weights. A learning rate that is too low might result in the machine learning algorithm 804 requiring multiple training passes to converge to the optimal weights.

The model size is regulated by the number of input features (“features”) 808 in the training data set 806. A greater the number of features 808 yields a greater number of possible patterns that can be determined from the training data set 806. The model size should be selected to balance the resources (e.g., compute, memory, storage, etc.) needed for training and the predictive power of the resultant machine learning model 802.

The number of training passes indicates the number of training passes that the machine learning algorithm 804 makes over the training data set 806 during the training process. The number of training passes can be adjusted based, for example, on the size of the training data set 806, with larger training data sets being exposed to fewer training passes in consideration of time and/or resource utilization. The effectiveness of the resultant machine learning model 802 can be increased by multiple training passes.

Data shuffling is a training parameter designed to prevent the machine learning algorithm 804 from reaching false optimal weights due to the order in which data contained in the training data set 806 is processed. For example, data provided in rows and columns might be analyzed first row, second row, third row, etc., and thus an optimal weight might be obtained well before a full range of data has been considered. By data shuffling, the data contained in the training data set 806 can be analyzed more thoroughly and mitigate bias in the resultant machine learning model 802.

Regularization is a training parameter that helps to prevent the machine learning model 802 from memorizing training data from the training data set 806. In other words, the machine learning model 802 fits the training data set 806, but the predictive performance of the machine learning model 802 is not acceptable. Regularization helps the machine learning system 800 avoid this overfitting/memorization problem by adjusting extreme weight values of the features 808. For example, a feature that has a small weight value relative to the weight values of the other features in the training data set 806 can be adjusted to zero.

The machine learning system 800 can determine model accuracy after training by using one or more evaluation data sets 810 containing the same features 808′ as the features 808 in the training data set 806. This also prevents the machine learning model 802 from simply memorizing the data contained in the training data set 806. The number of evaluation passes made by the machine learning system 800 can be regulated by a target model accuracy that, when reached, ends the evaluation process and the machine learning model 802 is considered ready for deployment.

After deployment, the machine learning model 802 can perform a prediction operation (“prediction”) 814 with an input data set 812 having the same features 808″ as the features 808 in the training data set 806 and the features 808′ of the evaluation data set 810. The results of the prediction 814 are included in an output data set 816 consisting of predicted data. The machine learning model 802 can perform other operations, such as regression, classification, and others. As such, the example illustrated in FIG. 8 should not be construed as being limiting in any way.

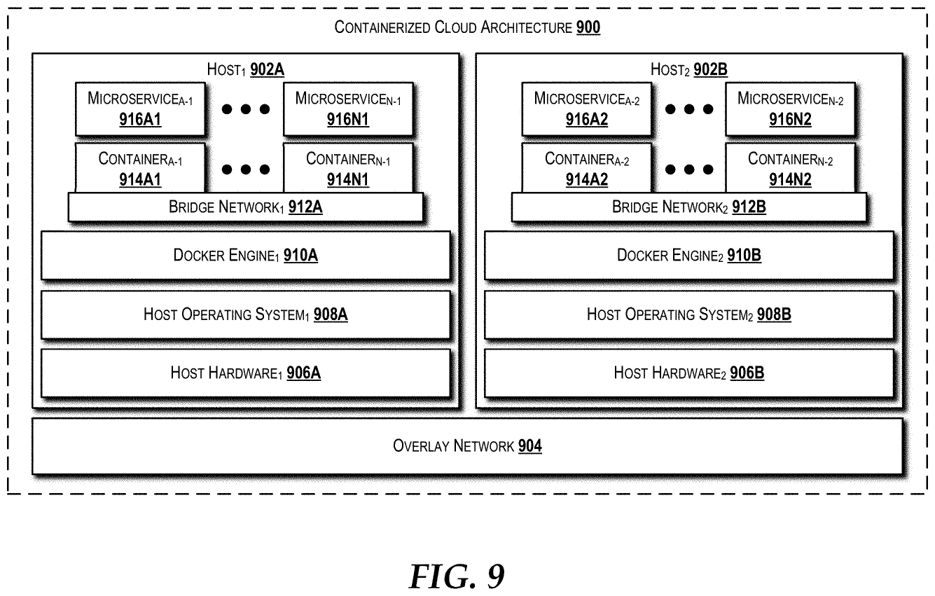

Turning now to FIG. 9, a block diagram illustrating an exemplary containerized cloud architecture 900 capable of implementing, at least in part, aspects of the concepts and technologies disclosed herein will be described, according to an illustrative embodiment. In some embodiments, the virtual meeting service 112, at least in part, is implemented in the containerized cloud architecture 900. The illustrated containerized cloud architecture 900 includes a first host (“host₁”) 902A and a second host (“host₂”) 902B (at times referred to herein collectively as hosts 902 or individually as host 902) that can communicate via an overlay network 904. Although two hosts 902 are shown, the containerized cloud architecture 900 can support any number of hosts 902. The overlay network 904 can enable communication among hosts 902 in the same cloud network or hosts 902 across different cloud networks. Moreover, the overlay network 904 can enable communication among hosts 902 owned and/or operated by the same or different entities.

The illustrated host₁ 902A includes a host hardware₁ 906A, a host operating system₁ 908A, a DOCKER engine₁ 910A, a bridge network₁ 912A, container_{A-1} through container_{N-1} 914A1-914N1, and microservice_{A-1} through microservice_{N-1} 916A1-916N1. Similarly, the illustrated host₂ 902B includes a host hardware₂ 906B, a host operating system₂ 908B, a DOCKER engine₂ 910B, a bridge network₂ 912B, container_{A-2} through container_{N-2} 914A2-914N2, and microservice_{A-2} through microservice_{N-2} 916A2-916N2.

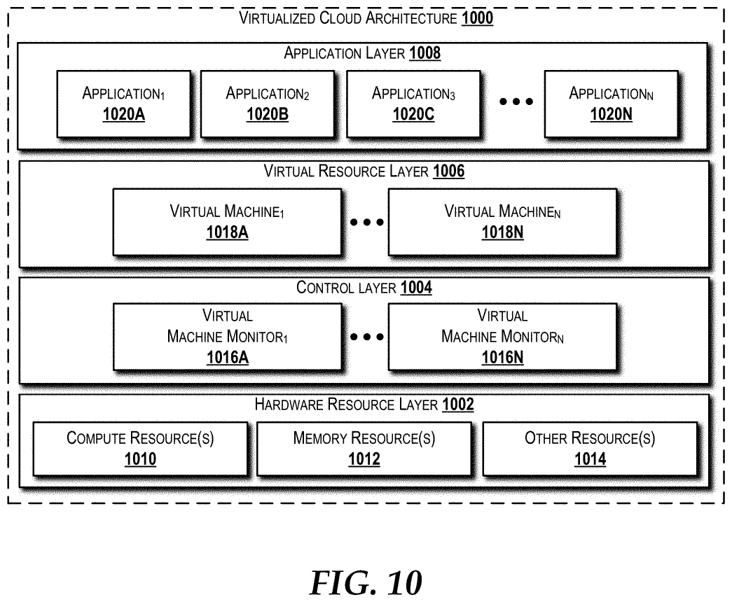

The host hardware₁ 906A and the host hardware₂ 906B (at times referred to herein collectively or individually as host hardware 906) can be implemented as bare metal hardware such as one or more physical servers. The host hardware 906 alternatively can be implemented using hardware virtualization. In some embodiments, the host hardware 906 can include compute resources, memory resources, and other hardware resources. These resources can be virtualized according to known virtualization techniques. A virtualization cloud architecture 1000 is described herein with reference to FIG. 10. Although the containerized cloud architecture 900 and the virtualization cloud architecture 1000 are described separately, these architectures can be combined to provide a hybrid containerized/virtualized cloud architecture. Those skilled in the art will appreciate that the disclosed cloud architectures are simplified for ease of explanation and can be altered as needed for any given implementation without departing from the scope of the concepts and technologies disclosed herein. As such, the containerized cloud architecture 900 and the virtualized cloud architecture 1000 should not be construed as being limiting in any way.

Compute resources can include one or more hardware components that perform computations to process data and/or to execute computer-executable instructions. For example, the compute resources can execute instructions of the host operating system₁ 908A and the host operating system₂ 908B (at times referred to herein collectively as host operating systems 908 or individually as host operating system 908), the containers 914A1-914N1 and the containers 914A2-914N2 (at times referred to herein collectively as containers 914 or individually as container 914), and the microservices 916A1-916N1 and the microservices 916A1-916N1 (at times referred to herein collectively as microservices 916 or individually as microservice 916).

The compute resources of the host hardware 906 can include one or more central processing units (“CPUs”) configured with one or more processing cores. The compute resources can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources can include one or more discrete GPUs. In some other embodiments, the compute resources can include CPU and GPU components that are configured in accordance with a co-processing CPU/GPU computing model, wherein the sequential part of an application executes on the CPU and the computationally-intensive part is accelerated by the GPU. The compute resources can include one or more system-on-chip (“SoC”) components along with one or more other components, including, for example, one or more memory resources, and/or one or more other resources. In some embodiments, the compute resources can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources can be or can include one or more hardware components architected in accordance with an advanced reduced instruction set computing (“RISC”) (“ARM”) architecture, available for license from ARM HOLDINGS. Alternatively, the compute resources can be or can include one or more hardware components architected in accordance with an x86 architecture, such an architecture available from INTEL CORPORATION, and others. Those skilled in the art will appreciate the implementation of the compute resources can utilize various computation architectures, and as such, the compute resources should not be construed as being limited to any particular computation architecture or combination of computation architectures, including those explicitly disclosed herein.

The memory resources of the host hardware 906 can include one or more hardware components that perform storage operations, including temporary or permanent storage operations. In some embodiments, the memory resource(s) include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources.

The other resource(s) of the host hardware 906 can include any other hardware resources that can be utilized by the compute resources(s) and/or the memory resource(s) to perform operations described herein. The other resource(s) can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The host operating systems 908 can be proprietary, open source, or closed source. In some embodiments, the host operating systems 908 can be or can include one or more container operating systems designed specifically to host containers such as the containers 914. For example, the host operating systems 908 can be or can include FEDORA COREOS (available from RED HAT, INC), RANCHEROS (available from RANCHER), and/or BOTTLEROCKET (available from Amazon Web Services). In some embodiments, the host operating systems 908 can be or can include one or more members of the WINDOWS family of operating systems from MICROSOFT CORPORATION (e.g., WINDOWS SERVER), the LINUX family of operating systems (e.g., CENTOS, DEBIAN, FEDORA, ORACLE LINUX, RHEL, SUSE, and UBUNTU), the SOLARIS family of operating systems from ORACLE CORPORATION, other operating systems, and the like.

The containerized cloud architecture 900 can be implemented utilizing any containerization technologies. Presently, open-source container technologies, such as those available from DOCKER, INC., are the most widely used, and it appears will continue to be for the foreseeable future. For this reason, the containerized cloud architecture 900 is described herein using DOCKER container technologies available from DOCKER, INC., such as the DOCKER engines 910. Those skilled in the art will appreciate that other container technologies, such as KUBERNETES may also be applicable to implementing the concepts and technologies disclosed herein, and as such, the containerized cloud architecture 900 is not limited to DOCKER container technologies. Moreover, although open-source container technologies are most widely used, the concepts and technologies disclosed here may be implemented using proprietary technologies or closed source technologies.

The DOCKER engines 910 are based on open source containerization technologies available from DOCKER, INC. The DOCKER engines 910 enable users (not shown) to build and containerize applications. The full breadth of functionality provided by the DOCKER engines 910 and associated components in the DOCKER architecture are beyond the scope of the present disclosure. As such, the primary functions of the DOCKER engines 910 will be described herein in brief, but this description should not be construed as limiting the functionality of the DOCKER engines 910 or any part of the associated DOCKER architecture. Instead, those skilled in the art will understand the implementation of the DOCKER engines 910 and other components of the DOCKER architecture to facilitate building and containerizing applications within the containerized cloud architecture 900.

The DOCKER engine 910 functions as a client-server application executed by the host operating system 908. The DOCKER engine 910 provides a server with a daemon process along with application programming interfaces (“APIs”) that specify interfaces that applications can use to communicate with and instruct the daemon to perform operations. The DOCKER engine 910 also provides a command line interface (“CLI”) that uses the APIs to control and interact with the daemon through scripting and/or CLI commands. The daemon can create and manage objects such as images, containers, networks, and volumes. Although a single DOCKER engine 910 is illustrated in each of the hosts 902, multiple DOCKER engines 910 are contemplated. The DOCKER engine(s) 910 can be run in swarm mode.

The bridge networks 912 enable the containers 914 connected to the same bridge network to communicate. For example, the bridge networks 912A enables communication among the containers 914A1-914N1, and the bridge network2 912B enables communication among the containers 914A2-914N2. In some embodiments, the bridge networks 912 are software network bridges implemented via the DOCKER bridge driver. The DOCKER bridge driver enables default and user-defined network bridges.

The containers 914 are runtime instances of images. The containers 914 are described herein specifically as DOCKER containers, although other containerization technologies are contemplated as noted above. Each container 914 can include an image, an execution environment, and a standard set of instructions.

The microservices 916 are applications that provide a single function. In some embodiments, each of the microservices 916 is provided by one of the containers 914, although each of the containers 914 may contain multiple microservices 916. For example, the microservices 916 can include, but are not limited, to server, database, and other executable applications to be run in an execution environment provided by a container 914. The microservices 916 can provide any type of functionality, and therefore all the possible functions cannot be listed herein. Those skilled in the art will appreciate the use of the microservices 916 along with the containers 914 to improve many aspects of the containerized cloud architecture 900, such as reliability, security, agility, and efficiency, for example. In some embodiments, the virtual meeting service 112 is implemented as one or more of the microservices 916.

Turning now to FIG. 10, a block diagram illustrating an example virtualized cloud architecture 1000 and components thereof will be described, according to an exemplary embodiment. The virtualized cloud architecture 1000 can be utilized to implement various elements disclosed herein. In some embodiments, the virtual meeting service 112, at least in part, is implemented in the virtualized cloud architecture 1000.

The virtualized cloud architecture 1000 is a shared infrastructure that can support multiple services and network applications. The illustrated virtualized cloud architecture 1000 includes a hardware resource layer 1002, a control layer 1004, a virtual resource layer 1006, and an application layer 1008 that work together to perform operations as will be described in detail herein.

The hardware resource layer 1002 provides hardware resources, which, in the illustrated embodiment, include one or more compute resources 1010, one or more memory resources 1012, and one or more other resources 1014. The compute resource(s) 1010 can include one or more hardware components that perform computations to process data, and/or to execute computer-executable instructions of one or more application programs, operating systems, and/or other software. The compute resources 1010 can include one or more central processing units (“CPUs”) configured with one or more processing cores. The compute resources 1010 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 1010 can include one or more discrete GPUs. In some other embodiments, the compute resources 1010 can include CPU and GPU components that are configured in accordance with a co-processing CPU/GPU computing model, wherein the sequential part of an application executes on the CPU and the computationally-intensive part is accelerated by the GPU. The compute resources 1010 can include one or more system-on-chip (“SoC”) components along with one or more other components, including, for example, one or more of the memory resources 1012, and/or one or more of the other resources 1014. In some embodiments, the compute resources 1010 can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources 1010 can be or can include one or more hardware components architected in accordance with an advanced reduced instruction set computing (“RISC”) machine (“ARM”) architecture, available for license from ARM HOLDINGS. Alternatively, the compute resources 1010 can be or can include one or more hardware components architected in accordance with an x86 architecture, such an architecture available from INTEL CORPORATION of Mountain View, Calif., and others. Those skilled in the art will appreciate the implementation of the compute resources 1010 can utilize various computation architectures, and as such, the compute resources 1010 should not be construed as being limited to any particular computation architecture or combination of computation architectures, including those explicitly disclosed herein.

The memory resource(s) 1012 can include one or more hardware components that perform storage operations, including temporary or permanent storage operations. In some embodiments, the memory resource(s) 1012 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 1010.

The other resource(s) 1014 can include any other hardware resources that can be utilized by the compute resources(s) 1010 and/or the memory resource(s) 1012 to perform operations described herein. The other resource(s) 1014 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 1002 can be virtualized by one or more virtual machine monitors (“VMMs”) 1016A-1016N (also known as “hypervisors”; hereinafter “VMMs 1016”) operating within the control layer 1004 to manage one or more virtual resources that reside in the virtual resource layer 1006. The VMMs 1016 can be or can include software, firmware, and/or hardware that alone or in combination with other software, firmware, and/or hardware, manages one or more virtual resources operating within the virtual resource layer 1006.

The virtual resources operating within the virtual resource layer 1006 can include abstractions of at least a portion of the compute resources 1010, the memory resources 1012, the other resources 1014, or any combination thereof. These abstractions are referred to herein as virtual machines (“VMs”). In the illustrated embodiment, the virtual resource layer 1006 includes VMs 1018A-1018N (hereinafter “VMs 1018”). Each of the VMs 1018 can execute one or more applications 1020A-1020N in the application layer 1008.

Based on the foregoing, it should be appreciated that aspects of secure virtual meetings have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
identifying, by a secure virtual meeting module executed by a processing component of a user system, a user that is to participate in a virtual meeting;
identifying, by the secure virtual meeting module, an authorized meeting environment in which the user is authorized to participate in the virtual meeting;
determining, by the secure virtual meeting module, if the user is present in the authorized meeting environment;
determining, by the secure virtual meeting module, if an unauthorized person is present in the authorized meeting environment;
determining, by the secure virtual meeting module, if a device is operating in a listening mode; and
in response to determining that the user is present in the authorized meeting environment, the unauthorized person is not present in the authorized meeting environment, and the device is not operating in the listening mode, instructing, by the secure virtual meeting module, a virtual meeting application also executed by the processing component of the user system, to begin the virtual meeting.

2. The method of claim 1, wherein identifying, by the secure virtual meeting module, the user that is to participate in the virtual meeting comprises utilizing a camera component of the user system to identify the user.

3. The method of claim 2, wherein identifying, by the secure virtual meeting module, the user that is to participate in the virtual meeting further comprises utilizing a facial recognition technology to identify the user.

4. The method of claim 1, wherein identifying, by the secure virtual meeting module, the authorized meeting environment in which the user is authorized to participate in the virtual meeting comprises identifying, by the secure virtual meeting module, the authorized meeting environment as an entire field of view of a camera component of the user system.

5. The method of claim 1, wherein identifying, by the secure virtual meeting module, the authorized meeting environment in which the user is authorized to participate in the virtual meeting comprises identifying, by the secure virtual meeting module, the authorized meeting environment as a portion of a field of view of a camera component of the user system.

6. The method of claim 5, wherein the portion of the field of view of the camera component of the user system is defined, at least in part, by a virtual boundary.

7. The method of claim 5, wherein the portion of the field of view of the camera component of the user system is defined, at least in part, by a policy.

8. The method of claim 1, wherein, in response to determining that the user is not present in the authorized meeting environment, instructing, by the secure virtual meeting module, the virtual meeting application to delay the virtual meeting.

9. The method of claim 1, wherein, in response to determining that the unauthorized person is present in the authorized meeting environment or that the device is operating in the listening mode, presenting a warning to the user.

10. The method of claim 1, wherein, in response to determining that the unauthorized person is present in the authorized meeting environment or that the device is operating in the listening mode, generating and sending an alarm to a meeting data owner.

11. The method of claim 1, wherein, in response to determining that the unauthorized person is present in the authorized meeting environment or that the device is operating in the listening mode, performing a remedial action.

12. A computer-readable storage medium having computer-executable instructions stored thereon that, when executed by a processing component of a user system, cause the processing component to perform operations comprising:
identifying a user that is to participate in a virtual meeting;
identifying an authorized meeting environment in which the user is authorized to participate in the virtual meeting;
determining if the user is present in the authorized meeting environment;
determining if an unauthorized person is present in the authorized meeting environment;
determining if a device is operating in a listening mode; and
in response to determining that the user is present in the authorized meeting environment, the unauthorized person is not present in the authorized meeting environment, and the device is not operating in the listening mode, instructing, by the secure virtual meeting module, a virtual meeting application also executed by the processing component of the user system, to begin the virtual meeting.

13. The computer-readable storage medium of claim 12, wherein, in response to determining that the user is not present in the authorized meeting environment, instructing the virtual meeting application to delay the virtual meeting.

14. The computer-readable storage medium of claim 12, wherein, in response to determining that the unauthorized person is present in the authorized meeting environment or that the device is operating in the listening mode, presenting a warning to the user.

15. The computer-readable storage medium of claim 12, wherein, in response to determining that the unauthorized person is present in the authorized meeting environment or that the device is operating in the listening mode, generating and sending an alarm to a meeting data owner.

16. The computer-readable storage medium of claim 12, wherein, in response to determining that the unauthorized person is present in the authorized meeting environment or that the device is operating in the listening mode, performing a remedial action.

17. A method comprising:
monitoring, by a secure virtual meeting module executed by a processing component of a user system, an authorized meeting environment of a user participating in a virtual meeting;
determining, by the secure virtual meeting module, if the user is present in the authorized meeting environment;
determining, by the secure virtual meeting module, if an unauthorized person is present in the authorized meeting environment;
determining, by the secure virtual meeting module, if a device is operating in a listening mode; and
in response to determining that the user is not present in the authorized meeting environment, the unauthorized person is present in the authorized meeting environment, or the device is operating in the listening mode, generating, by the secure virtual meeting module, an alarm.

18. The method of claim 17, further comprising:
generating, by the secure virtual meeting module, a report comprising the alarm; and
causing, by the secure virtual meeting module, the user system to send the report to a meeting data owner.

19. The method of claim 18, wherein generating, by the secure virtual meeting module, the report comprises generating, by the secure virtual meeting module, the report based upon a policy.

20. The method of claim 17, wherein generating, by the secure virtual meeting module, the alarm comprises generating, by the secure virtual meeting module, the alarm based upon a policy.
